(19) United States
(12) Patent Application Publication
(10) Pub. No.: US 2007/0293298 A1
(43) Pub. Date: Dec. 20, 2007

(54) Slot machine and playing method thereof

(75) Inventor: Kazuo Okada, Tokyo (JP)

Correspondence Address: NDQ&M WATCHSTONE LLP, 1300 EYE STREET, NW, SUITE 1000 WEST TOWER, WASHINGTON, DC, 20005, US

(73) Assignee: ARUZE GAMING AMERICA, INC., Las Vegas, NV (US)

(21) Appl. No.: 11/582,419

(22) Filed: Oct. 18, 2006

Related U.S. Application Data
(60) Provisional application No. 60/814,892, filed on Jun. 20, 2006.

(51) Int. Cl. A63F 13/00

(52) U.S. Cl. 463/20

(57) ABSTRACT

In a unit game during the execution of the base game, if a combination of symbols at a time when the reels are stopped is “BELL-BELL-BELL”, the stop control game is executed. In the stop control game, the player stops the rotating reel by pressing a stop switch, and if the symbols are stopped at the winning combination, the payout according to the winning combination is made. Also, in the stop control game, it is set to be capable of being stopped at the combination of symbols “PLUM-PLUM-PLUM” or “PLUM-PLUM-MELON”, and the greater payout amount is paid for the combination “PLUM-PLUM-PLUM” than the combination “PLUM-PLUM-MELON”.

### CROSS REFERENCE TO RELATED APPLICATIONS

This application claims priority to co-pending U.S. provisional patent application Ser. No. 60/814,892 filed on Jun. 20, 2006, and which is incorporated by reference herein for all purposes.

### BACKGROUND OF THE INVENTION

1. Field of the Invention

The present invention relates to a slot machine for playing games by using a game medium such as coin or bill, and a playing method of the slot machine.

2. Description of Related Art

In the related slot machine such as those disclosed in U.S. Pat. No. 6,960,133 and U.S. Pat. No. 6,012,983, when a player inserts the game medium such as medal, coin or bill into an insertion slot of the slot machine and presses a spin button, a plurality of symbols are scrolled at a display unit provided on a front side of a cabinet, and then each symbol is automatically stopped. At this point, the lottery of random numbers is held at a time of the start of the scrolling of each symbol which is triggered by the pressing of the spin button, and if a transition to a bonus game such as mystery bonus or second game is won, a transition from the base game to the bonus game is made and the bonus game is played.

Then, the slot machine is made to pay out a prize according to the winning combination that occurs in the course of the game.

In such a related slot machine, the game comprises only the automatic stopping of the scrolled symbols, so that there are demands for new slot machines that are much more entertaining.

### SUMMARY OF THE INVENTION

The first aspect of the present invention is a slot machine comprising a controller operable to, in a case of rearranging a plurality of symbols arranged on a display, when the symbols are rearranged into a specific combination, make a transition to a stop control game in which the symbols can be rearranged into a plurality of winning combinations according to a control input signal from an external.

In the slot machine of the first aspect of the present invention, when the symbols are rearranged into a specific combination on the display, a transition to a stop control game is made, and the controller accepts a control input signal from an external and it is set such that the symbols can be rearranged into a plurality of winning combinations.

The second aspect of the present invention is a slot machine comprising a controller operable to, wherein in a case of rearranging a plurality of symbols arranged on a display, when the symbols are rearranged into a specific combination, make a transition to a stop control game in which, according to a control input signal from an external, the symbols can be rearranged into a first winning combination associated with a payout or a second winning combination associated with a less amount of payout than the first winning combination.

In the slot machine of the second aspect of the present invention, when the symbols are rearranged into a specific combination on the display, a transition from the base game to a stop control game is made. In the stop control game, the symbols are rearranged according to a control input signal from an external. Also, in the stop control game, the controller is set to be capable of rearranging the symbols into the first winning combination or the second winning combination. Also, the first winning combination and the second winning combination are associated with the payout, where the amount of payout by the second winning combination is set to be less than the amount of payout by the first winning combination.

The third aspect of the present invention is a slot machine, comprising: a display on which a symbol matrix formed by a plurality of columns and a plurality of rows is to be arranged; an arrangement controller operable to execute an arrangement control in which a plurality of symbols arranged on the display are scrolled and then rearranged into a new symbol matrix, by selectively determining those symbols to be arranged into the symbol matrix from a plurality of types of symbols and stopping scrolling at determined symbols; a stop switch connected to the arrangement controller and operable by a player; and a stop switch controller operable to set the stop switch active when the symbols are rearranged into a specific combination on a payline that is set with respect to the symbol matrix, and enable rearrangement of the symbols into a first winning combination or a second winning combination that is determined by the arrangement controller in relation to an input timing of the stop switch by the player.

In the slot machine of the third aspect of the present invention, a stop switch that can be operated by the player is provided. Then, in a case where the symbols are rearranged into a specific combination on a payline by the arrangement controller, the operation of the stop switch is set active. Then, the stop switch controller carries out a control for rearranging scrolled symbols, in relation to a timing at which the stop switch is operated. The stop switch controller is set to be capable of rearranging the scrolled symbols into the first winning combination or the second winning combination.

The fourth aspect of the present invention is a playing method of a slot machine, comprising: repeating unit games in which a plurality of symbols are rearranged from a state of being arranged on a display into a combination of symbols determined by a controller; and accepting an arrangement signal due to an operation of a player at the controller and enabling rearrangement of the symbols into a plurality of winning combinations, only in a case where a combination of symbols rearranged on the display is a specific combination of symbols.

In the playing method of a slot machine of the fourth aspect of the present invention, when the combination of symbols rearranged on the display becomes a specific combination, the rearrangement of the symbols by the arrangement signal due to the operation of the player becomes possible. Also, the controller is set to be capable of rearranging the symbols into a plurality of winning combinations.

The fifth aspect of the present invention is a playing method of a slot machine, comprising: determining a plurality of symbols to be rearranged at a controller, and enabling rearrangement of the plurality of symbols independently from a control of the controller by a stop switch connected to the controller, prior to the rearrangement, in a case of arranging the plurality of symbols on a display and rearranging the plurality of symbols arranged on the display; rearranging the plurality of symbols by the combination of symbols on the display; enabling rearrangement of the plurality of symbols into a first winning combination associated with a prescribed amount of payout or a second winning combination associated with a less amount of payout than the first winning combination on the display, in a case where the combination of symbols rearranged on the display is a specific combination; and setting the stop switch active such that the rearrangement of the plurality of symbols is controlled by an input of the stop switch, in a case where the combination of symbols rearranged on the display is the specific combination.

In the playing method of a slot machine of the fifth aspect of the present invention, the symbols to be rearranged are determined by the controller, and in a case where the combination of symbols rearranged on the display is a specific combination, the operation of the stop switch is set active. Then, in relation to the operation of the stop switch, it is set such that the symbols can be rearranged into the first winning combination or the second winning combination. Also, the first winning combination and the second winning combination are associated with the payout, where, the amount of payout by the second winning combination is set to be less than the amount of payout by the first winning combination.

The sixth aspect of the present invention is a playing method of a slot machine, comprising: repeating a unit game in which a game is started as a plurality of symbols arranged on a display are scrolled by a control of a controller and a game is ended as the plurality of symbols are rearranged into a combination of symbols determined by the controller; setting a first control state in which the plurality of symbols scrolled on the display can be rearranged into a first winning combination or a second winning combination, according to an arrangement signal from a stop switch connected to the controller, in a case where the plurality of symbols are rearranged into a specific combination by the controller; judging whether the combination of symbols rearranged on the display is either one of the first winning combination and the second winning combination or not, in the first control state; and ending the unit game, and making a transition to a second control state in which the plurality of symbols are automatically rearranged from a state of being scrolled into the second winning combination by the controller, without being influenced by the arrangement signal from the stop switch, in a case where the combination of symbols rearranged on the display is judged as neither the first winning combination nor the second winning combination.

In the playing method of a slot machine of the sixth aspect of the present invention, a combination of the symbols to be rearranged is determined by the controller, and in a case where a combination of symbols rearranged on the display is a specific combination, it is set as the first control state. In the first control state, the stop switch is set active, and the scrolled symbols can be rearranged into the first winning combination or the second winning combination by the input signal from the stop switch. Also, in a case where the symbols were not rearranged into either one of the first winning combination and the second winning combination, it is set as the second control state. In the second control state, the symbols are scrolled again, and rearranged into the second winning combination, without being influenced by the operation of the stop switch. The above described stop switch may be a mechanical button switch, or a switch such as a touch panel, and it suffices to be a switch for triggering the generation of the input signal, which can be operated by the player from an external.

### BRIEF DESCRIPTION OF THE DRAWINGS

FIG. 1 is a flow chart showing a gaming method using a slot machine according to one embodiment of the present invention.

FIG. 2 is a diagram showing an outward appearance of a slot machine according to one embodiment of the present invention.

FIG. 3 is a diagram showing symbols displayed on three reels provided in the slot machine and code numbers of the symbols according to one embodiment of the present invention.

FIG. 4 is a block diagram showing a control circuit of the slot machine according to one embodiment of the present invention.

FIG. 5 is a flow chart showing a procedure of an authentication and reading processing of a game program and a game system program by a mother board and a gaming board of the slot machine according to one embodiment of the present invention.

FIG. 6 is a flow chart showing a processing procedure of a base game to be executed by the slot machine according to one embodiment of the present invention.

FIG. 7 is a flow chart showing a processing procedure of a stop control game to be executed by the slot machine according to one embodiment of the present invention.

FIG. 8 is a flow chart showing a procedure of a lottery processing to be executed by the slot machine according to one embodiment of the present invention.

FIG. 9 is a diagram showing a relationship among a plurality of types of winning combinations, their realization probabilities, and their payout amounts in the slot machine according to one embodiment of the present invention.

FIG. 10 is a flow chart showing a procedure of a reel rotation control processing to be executed by the slot machine according to one embodiment of the present invention.

FIGS. 11A, 11B, 11C and 11D are diagrams showing rotation operations of the reel in the slot machine according to one embodiment of the present invention.

FIG. 12 is a diagram showing a correspondence of the number of steps and the code number in the slot machine according to one embodiment of the present invention.

FIG. 13 is a flow chart showing a processing procedure of a bonus game to be executed in the slot machine according to one embodiment of the present invention.

FIG. 14 is a diagram showing an exemplary display for notifying that the stop control game is played, in the slot machine according to one embodiment of the present invention.

FIG. 15 is a diagram showing an exemplary case of displaying the symbols by images in the slot machine according to one embodiment of the present invention.

### DETAILED DESCRIPTION OF THE INVENTION

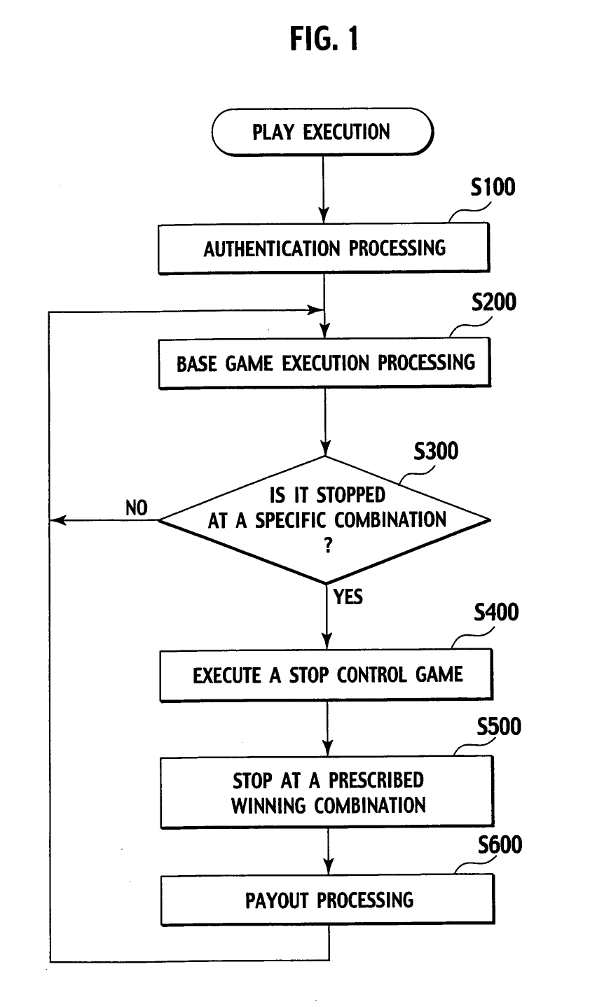

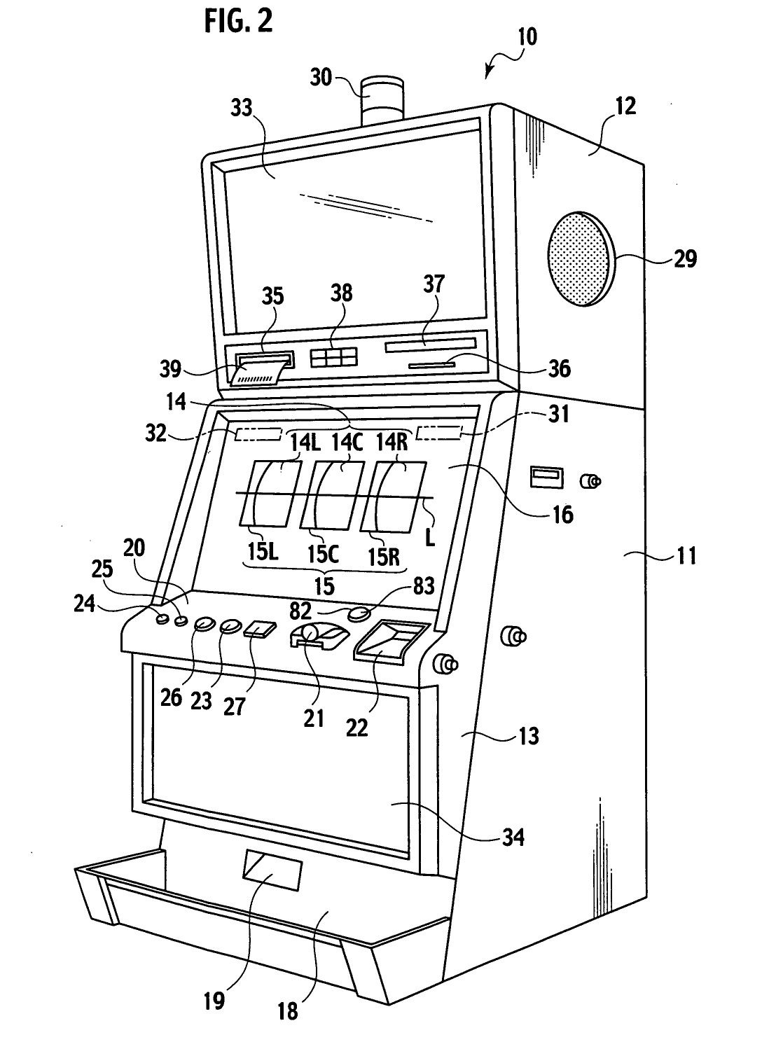

FIG. 1 is a flow chart schematically showing a gaming method using a slot machine according to one embodiment of the present invention. In the following, the schematic operations in the slot machine and the playing method according to one embodiment of the present invention will be described with references to the flow chart shown in FIG. 1 and a diagram shown in FIG. 2.

In the slot machine according to one embodiment of the present invention, when the power is turned on and the slot machine is activated, an authentication processing is carried out first (step S100). In this authentication processing, the initial checking processing at a preliminary stage before starting a unit game, such as whether a program for operating the system is operating normally or not, whether there is any falsification of a program or not, etc., is carried out.

Next, a base game is executed (step S200). In this base game, hen a spin button 23 is pressed in a state where a desired credit amount is bet by entering coins into a coin slot 21 or the like, a unit game in which three reels 14 (14L, 14C, 14R) are rotated and then stopped is executed. Each unit game contains a lottery for determining the winning or losing of a bonus game, in which a lottery of symbols at which the reels 14 (14L, 14C, 14R) are to be stooped is carried out.

Next, when the reels 14 (14L, 14C, 14R) are stopped at the symbols determined by the above described lottery result, whether a combination of symbols at which the reels 14 are stopped is a specific combination or not is judged (step S300). Then, in the case where a symbol “BELL” shown on an outer circumferential surface of each reel 14 is stopped on a payline L of a display position of a display window 15 that is visible to the player, and the reels 14 (14L, 14C, 14R) have been stopped at a specific combination of symbols such as “BELL-BELL-BELL”, for example (step S300 YES), a stop control game is executed (step S400). The stop control game is a game in which the reels 14 (14L, 14C, 14R) are rotated and then the reels 14 are stopped when a stop switch 82 is pressed by the player. In the present embodiment, after the reels 14 (14L, 14C, 14R) start rotating, two reels 14L and 14C are stopped automatically while the remaining one reel 14R continues rotating, and the reel 14R is stopped at a timing of the pressing of the stop switch 82 by the player. It is also possible to stop all three reels 14 (14L, 14C, 14R) or two of the reels 14 by the stopping operation by the player.

In the stop control game, a plurality of winning combinations are set to be capable of being stopped at the display position of the display window 15. As an example, two winning combinations including a winning combination “PLUM-PLUM-PLUM” and a winning combination “PLUM-PLUM-MELON” are set to be capable of being stopped.

At this point, as described below, the winning combination “PLUM-PLUM-PLUM” has the payout of four coins for each one coin entered, and the winning combination “PLUM-PLUM-MELON” has the payout of two coins for each one coin entered. Namely, the winning combination “PLUM-PLUM-PLUM” is the first winning combination associated with a prescribed payout, and the winning combination “PLUM-PLUM-MELON” is the second winning combination associated with the amount of payout less than the amount of payout of the first winning combination.

For the symbols that constitute each winning combinations, there are two cases of stopping at them and not stopping at them, depending on a timing at which the player presses the stop switch 82. More specifically, the reels 14 are rotated, and after a prescribed time, the left reel 14L and the center reel 14C are automatically stopped at the symbol “PLUM”, and the right reel 14R which is the remaining reel can be stopped by the player by pressing the stop switch 82. Then, depending on a timing at which the player presses the stop switch 82, the right reel 14R can be stopped at the symbol “PLUM”, at the symbol “MELON”, or at the symbol other than these.

When the player pressed the stop switch 82, the symbol “PLUM” will be stopped on the payline L in the case where the symbol “PLUM” of the rotating reel 14R is located right on a position of the display window 15R (on the payline L) or the symbol “PLUM” is located at a nearby position on the upper side of the display window 15R.

Similarly, when the player pressed the stop switch 82, the symbol “MELON” will be stopped on the payline L in the case where the rotating reel 14R is located right on a position of the display window 15R (on the payline L) or the symbol “MELON” is located at a nearby position on the upper side of the display window 15R. Also, in the case where the symbols “PLUM” and “MELON” are not located at the above described positions, the symbol “PLUM” or “MELON” will not be stopped on the payline L.

Also, in the case where the right reel 14R is stopped at the symbol other than “PLUM” and “MELON”, the right reel 14R is rotated again and automatically stopped at the symbol “MELON”.

Namely, in the case where the stop control game is executed, depending on a timing at which the player presses the stop switch 82, the symbols are stopped at either one of the winning combinations including the first winning combination “PLUM-PLUM-PLUM” and the second winning combination “PLUM-PLUM-MELON” (step S500).

After that, the payout according to the winning combination at which the symbols are stopped is made (step S600). For example, in the case where the symbols are stopped at the first winning combination “PLUM-PLUM-PLUM”, the payout of four coins for each one coin entered is made, and in the case where the symbols are stopped at the second winning combination “PLUM-PLUM-MELON”, the payout of two coins for each one coin entered is made.

In the above described example, a horizontal line displayed at a center of the display window 15 shown in FIG. 2 is set as the payline L, but it is also possible to set the other straight line consisted of three symbols displayed in the display window 15 such as an upper level line, a lower level line or an oblique line as the payline L such that the transition to the stop control game is made when the symbols “BELL-BELL-BELL” are stopped on such a payline L. Moreover, it is also possible to make the transition to the stop control game in the case where one of the symbols of the reels 14 displayed in the display window 15 is the symbol “BELL”, without using the straight line.

The above described example is directed to the case of having three reels 14 (14L, 14C, 14R), but it is also possible to have the other number of reels such as five reels, for example, or one reel. Also, it is not limited to the case of using mechanical reels as in the present embodiment, and it is possible to apply the present invention to the slot machine using video reels.

The above described example is directed to an exemplary case of arranging symbols in the display window 15 by rotating the reels 14, but it is also possible to display images of the symbols on the display window 15 and the images of the symbols arranged on the display window 15 are displayed (rearranged) by changing them to images of the other symbols in each unit game, for example.

Next, a configuration of the slot machine 10 according to one embodiment of the present invention will be described with reference to a diagram shown in FIG. 2. The slot machine 10 is provided within a gaming facility.

In the slot machine 10, the coins, bills or electronic value information corresponding to these will be used as the game medium for executing the unit game. However, the game medium that can be used in the present invention is not limited to these, and can be medals, tokens, electronic money, or tickets, for example. The tickets are not limited to any particular tickets and can be tickets with bar codes, for example, as will be described below.

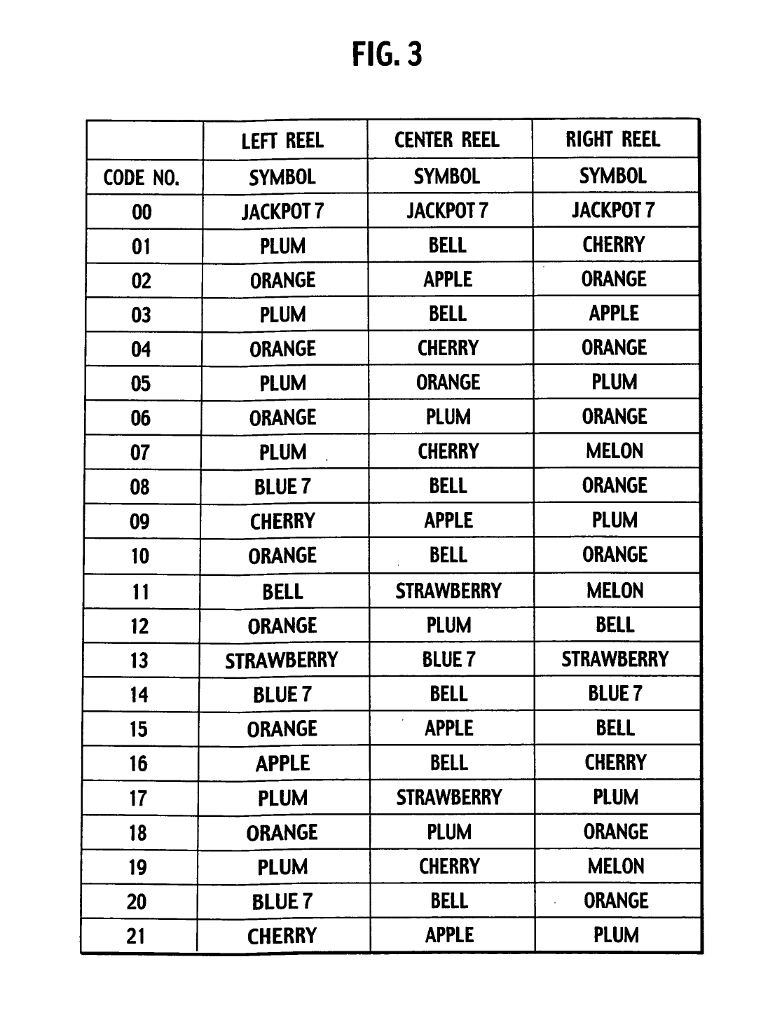

As shown in FIG. 2, the slot machine 10 has a cabinet 11, a top box 12 provided on an upper side of the cabinet 11, and a main door 13 provided on a front side of the cabinet 11. Inside the cabinet 11, three reels 14 (14L, 14C, 14R)(display) are provided to be rotatable. On an outer circumferential surface of each reel 14, a series of symbols formed by 22 symbols are depicted, as shown in FIG. 3. Namely, the three reels 14 (display) display a symbol matrix formed by a plurality of columns and a plurality of rows. The present embodiment is directed to an exemplary case of using three rotatable reels as the display, but it is also possible to display symbols by scrolling on an image display device such as a liquid crystal display device. Also, the number of reels 14 is not limited to three.

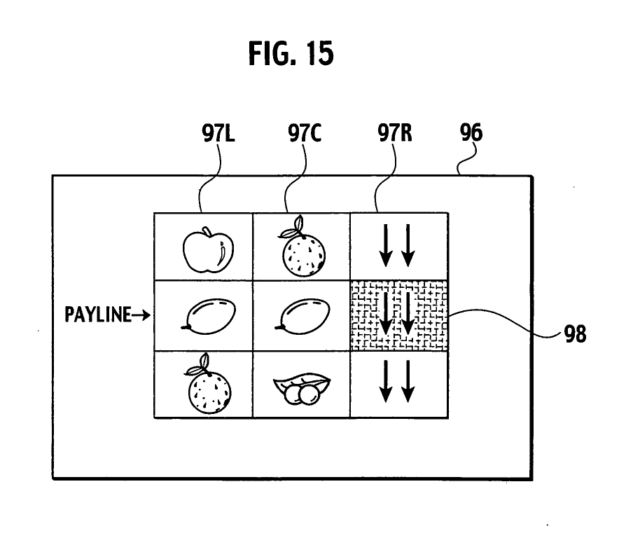

FIG. 15 is a diagram showing an exemplary modified display. As shown in FIG. 15, this display displays an image of the symbol matrix formed by three columns and three rows on a lower part display panel 96. Then, when the spin button 23 is pressed, the left column symbols 97L, the center column symbols 97C, and the right column symbols 97R are scrolled, and after a prescribed time has elapsed, each symbol is automatically stopped. Also, in the case where the stop control game is executed, the middle row symbols that constitute the payline among the left column symbols 97L and the center column symbols 97C are stopped at the symbol “PLUM”. Moreover, a surrounding of the middle row display window 98 of the right column symbols 97R is lit up brightly. Then, when the display window 98 is touched by the player, this operation is detected and the right column symbols 97R that are scrolled are stopped. Then, according to a timing of this stopping operation, the symbol to be stopped at the middle row of the center column symbols 97C is determined. Even in the case of using such a configuration, the stop control game can be executed similarly as in the case of using three reels 14 (14L, 14C, 14R).

On a front side of each reel 14 in the main door 13 shown in FIG. 2, a lower side image display panel 16 is provided. The lower side image display panel 16 has a transparent liquid crystal panel, on which various information regarding the game and the effect images will be displayed during the game.

On the lower side image display panel 16, a credit amount display unit 31 and a payout amount display unit 32 are provided. On the credit amount display unit 31, the number of coins credited is displayed by an image. On the payout amount display unit 32, the number of coins to be paid in the case where a combination of symbols that are stopped on the payline L is the winning combination as will be described below is displayed by an image.

On the lower side image display panel 16, three display windows 15 (15L, 15C, 15R) are formed such that their back sides are visible, and three of the symbols depicted on the outer circumferential surface of each reel 14 (14L, 14C, 14R) are displayed in each instance through each display window 15. On the lower side image display panel 16, one payline L that runs across the three display windows 15 horizontally is formed. The payline L specifies a combination of symbols. In the case where a combination of symbols that are stopped on the payline L is the winning combination, the number of coins according to the number of entered coins (BET number) and that combination of symbols will be paid.

In the present embodiment, an exemplary case of setting one payline L will be described, but it is also possible to set payline L that runs across three display windows 15 horizontally and payline L that runs across three display windows 15 obliquely such that as many paylines L as according to the number of coins entered are set active and the payout of as many coins as according to the winning combination will be made in the case where a combination of symbols which are stopped on the active paylines L is the winning combination.

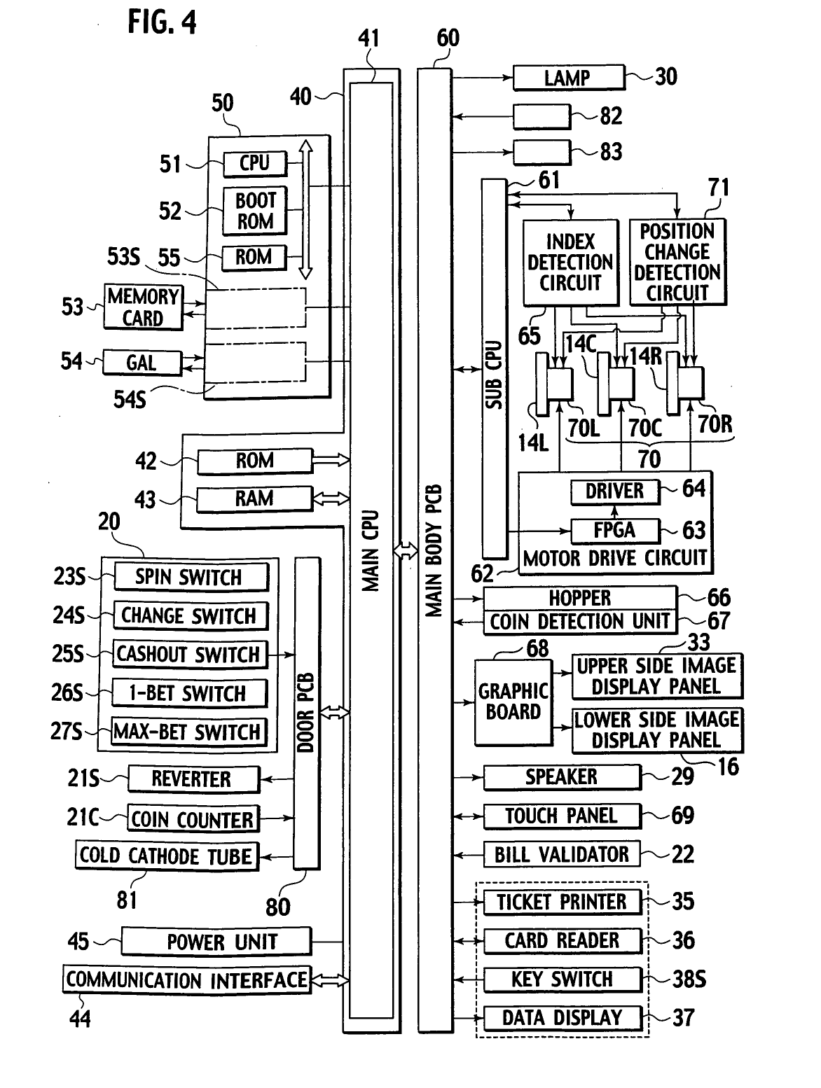

On a front face of the lower side image display panel 16, a touch panel 69 (see FIG. 4) is provided, such that the player can input various types of commands by operating the touch panel 69.

On a lower side of the lower side image display panel 16, a control panel 20 having a plurality of buttons 23-27 through which commands regarding the progress of the game will be inputted by the player, the stop switch 82, the coin slot 21 for receiving coins into the cabinet 11, and a bill validator 22 are provided.

It is also possible to arrange a transparent touch panel on a front side of the display windows 15 and use this touch panel as the stop switch 82. For such a touch panel, the touch panel used in the mobile terminal or the bank's ATM can be used. By arranging a touch panel on a front side of the display windows 15 as the stop switch 82 in this way, the player can enter a command for the rearrangement by watching the changing states of the scrolled symbols through the display windows while the reels 14 rotate and touching the symbols at which it is desired to be stopped (rearranged) through the display windows. Such a rearrangement operation has an advantage in that it can be done in a manner that simulates the direct touching of the symbols.

The present embodiment is directed to a configuration in which the mechanical type stop switch 82 corresponding to one reel 14 is provided, but without being limited to this, it is also possible to use a configuration in which three stop switches 82 that contribute to the rearrangement of all three reels 14 are provided. In this way, it becomes possible to switch the playing mode from a playing mode in which the player contributes to the rearrangement of all (three in the present embodiment) reels 14 by the input of the stop switches to a playing mode in which the player contributes to the rearrangement of one of them only.

On the control panel 20, a spin button 23, a change button 24, a cashout button 25, a 1-BET button 26, and a Max-BET button 27 are provided. The spin button 23 is a button for inputting a command for starting rotating the reels 14. The change button 24 is a button to be used at a time of requesting changes to an attendant of the gaming facility. The cashout button 25 is a button for inputting a command for paying the credited coins to a coin tray 18.

The 1-BET button 26 is a button for inputting a command for betting one coin among the credited coins to the game. The Max-BET button 27 is a button for inputting a command for betting maximum number (50, for example) of coins that can be bet per game among the credited coins to the game.

The stop switch 82 is a switch for the player to carry out an operation to stop the rotating reel 14 (the right reel 14R in the present embodiment), which is set active when the stop control game is started. To the stop switch 82, a display lamp 83 is provided, and the display lamp 83 is lit when the operation of the stop switch 82 is set active so as to notify that the operation of the stop switch 82 is set active to the player, as will be described below. It is also possible to use an operation lever, a track ball, a touch panel, etc., instead of the stop switch 82.

The bill validator 22 validates whether a bill is the legitimate one or not and accepts a legitimate bill into the cabinet 11. The bill validator 22 may have a configuration capable of reading a bar code attached ticket 39 to be described below. On the lower front surface of the main door 13, that is on the lower part of the control panel 20, there is provided a berry glass 34 on which characters of the slot machine 10 and the like are depicted.

On a front surface of the top box 12, an upper side image display panel 33 is provided. The upper side image display panel 33 has a liquid crystal panel for displaying the effect image or the image for introducing the game content or explaining game rules, for example.

On the top box 12, a speaker 29 for outputting sound is provided. On the lower side of the upper side image display panel 33, a ticket printer 35, a card reader 36, a data display 37, and a key pad 38 are provided. The ticket printer 35 prints a bar code which encodes data such as the credit amount, the date and time, the identification number of the slot machine 10, etc., on the ticket, and outputs it as the bar code attached ticket 39. The player can use the bar code attached ticket 39 to play the game on another slot machine or exchange the bar code attached ticket 39 with the bills or the like at the cashier or the like of the gaming facility.

The card reader 36 carries out reading of data from a smart card and writing of data into a smart card. The smart card is a card to be owned by the player, which stores data for identifying the player or data regarding log of games played by the player, for example.

The data display 37 comprises a fluorescent display or the like, and displays data read by the card reader 36, or data inputted by the player through the key pad 38, for example. The key pad 38 inputs data and commands regarding the ticket issuance or the like.

FIG. 3 is a diagram showing a series of symbols depicted on the outer circumferential surface of each reel. On each of the outer circumferential surfaces of the left reel 14L, the center reel 14C and the right reel 14R, 22 symbols are displayed. The series of symbols displayed on each reel 14 is different from those on the other reels. Each series of symbols is formed by a combination of symbols “JACKPOT 7”, “BLUE 7”, “BELL”, “CHERRY”, “STRAWBERRY”, “PLUM”, “ORANGE”, “APPLE”, and “MELON”.

Each of the symbols “JACKPOT 7”, “BLUE 7”, “BELL”, “CHERRY”, “STRAWBERRY”, “PLUM”, and “ORANGE” is such that, when three identical symbols are stopped on the payline L, a predetermined credit amount is added as the credit owned by the player (see FIG. 9). Also, each of the symbols “CHERRY” and “ORANGE” is such that, when one or two identical symbols are stopped on the payline L, a predetermined credit amount according to the number of identical symbols is added as the credit owned by the player, without requiring three identical symbols.

The symbol “APPLE” is a symbol for realizing a bonus game trigger (a symbol for making a transition to a bonus game). When three “APPLE” symbols are stopped on the payline L, a transition to the bonus game is made. The bonus game is a game mode that is more advantageous to the player than the base game. In the present embodiment, the bonus game is a free game (a game that can be played for a prescribed number of times without requiring BET of coins). In the present invention, the bonus game is not limited to any particular game as long as it is a game mode that is more advantageous to the player. The bonus game that is more advantageous to the player is not limited to any particular game as long as it is more advantageous than the base game, such as a mode in which more gaming media can be obtained than the base game, a mode in which the gaming medium can be obtained at a higher probability than the base game, or a mode in which the gaming medium is consumed less than the base game, for example. More specifically, the bonus game can be a free game, a second game, etc.

The symbol “BELL” is a symbol for triggering a transition to the stop control game. When symbols “BELL-BELL-BELL” are stopped on the payline L formed by the three reels 14 (14L, 14C, 14R), a transition to the stop control game is made. Namely, the symbols “BELL-BELL-BELL” constitute a specific combination.

The reels 14 (14L, 14C, 14R) will start rotating when the 1-BET button 26 or the Max-BET button 27 is pressed and then the spin button 23 is pressed. In conjunction with the rotation of the reels 14, the symbols displayed on outer circumferential surfaces of the reels 14 (14L, 14C, 14R) are scrolled from an upper direction to a lower direction at the display windows 15, and after a prescribed time has elapsed, the rotation of the reels 14 (14L, 14C, 14R) is stopped. At this point, one of the symbols displayed on an outer circumferential surface of each reel 14 is stopped at the display windows 15. A game from a start of the rotation of the reels 14 until the subsequent stopping of the rotation will constitute the unit game. Namely, a game in which symbols arranged on the display are scrolled and rearranged will constitute the unit game.

For each symbol, various types of winning combinations are predetermined (see FIG. 9), and when the symbols that constitute the winning combination are stopped on the payline L, the number of coins to be paid according to the winning combination is added to the credit owned by the player. When three “BELL” symbols are stopped on the payline L, a transition of the game mode from the base game mode to the stop control game mode is made.

FIG. 4 is a block diagram showing a control circuit of the slot machine 10 shown in FIG. 2. As shown in FIG. 4, the control circuit comprises a mother board 40, a main body PCB (Printed Circuit Board) 60, a gaming board 50, a sub CPU 61, a door PCB 80, and various types of switches and sensors.

The gaming board 50 has a CPU (Central Processing Unit) 51, a ROM 55 and a boot ROM 52, a card slot 53S corresponding to a memory card 53, and an IC socket 54S corresponding to a GAL (Generic Array Logic) 54, which are mutually connected through an internal bus.

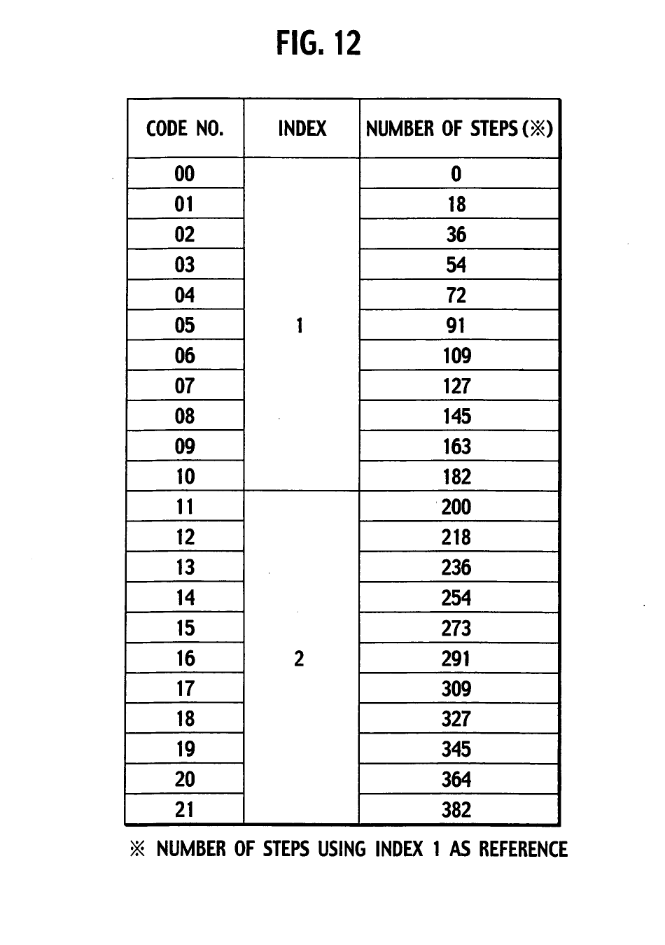

The memory card 53 stores a game program and a game system program. The game program includes a lottery program. The lottery program is a program for determining a symbol (a code number corresponding to a symbol) on each reel 14 that is to be stopped on the payline L. The lottery program contains symbol weighing data respectively corresponding to plural types of payout rates (80%, 84%, 88%, for example). The symbol weighing data are data indicating the correspondence relationship between the code number of each symbol (see FIG. 12), and one or a plurality of random number values belonging to a prescribed numerical value range (0 to 256), for each of the three reels 14 (14L, 14C, 14R).

The payout rate is determined according to the payout rate setting data outputted from the GAL 54. The lottery is carried out according to the symbol weighing data corresponding to the payout rate.

The card slot 53S is formed such that the memory card 53 can be inserted or extracted, and connected to the mother board 40 through the IDE bus. Consequently, by extracting the memory card 53 from the card slot 53S, writing the other game program and game system program into the memory card 53, and inserting that memory card 53 into the card slot 53S, it is possible to change a type and a content of the game to be played on the slot machine 10.

The game program includes a program related to the game progress and a program for making a transition to the bonus game. The game program also contains the image data and sound data to be outputted during the game. The game program also contains the image data and the sound data as notification data for notifying that the stopping operation of the right reel 14R by the stop switch 82 is possible to the player, when the combination of “BELL” symbols are stopped on the payline L and the transition to the stop control game is made.

The GAL 54 has a plurality of input ports and output ports, and when data are inputted into the input ports, data corresponding to these data are outputted from the output ports. The data outputted from the output ports are the payout rate setting data mentioned above.

The IC socket 54S is formed such that the GAL 54 can be attached or detached, and connected to the mother board 40 through the PCI bus. Consequently, by detaching the GAL 54 from the IC socket 54S, rewriting the program stored in the GAL 54, and attaching that GAL 54 to the IC socket 54S, it is possible to change the payout rate setting data to be outputted from the GAL 54.

The CPU 51, the ROM 55 and the boot ROM 52 that are mutually connected through the internal bus are connected to the mother board 40 through the PCI bus. The PCI bus carries out the signal transmission between the mother board 40 and the gaming board 50, as well as the power supply from the mother board 40 to the gaming board 50. The ROM 55 stores a country identification information and an authentication program. The boot ROM 52 stores a spare authentication program and a program (boot codes) for the CPU 51 to activate the spare authentication program.

The authentication program is a program (falsification checking program) for authenticating the game program and the game system program. Namely, the authentication program is a program for carrying out the checking and the verification of the fact that the game program and the game system program are not falsified. The authentication program is described along a procedure for carrying the authentication of the game program and the game system program. The spare authentication program is a program for authenticating the above described authentication program. The spare authentication program is described along a procedure for carrying out the verification that the authentication program that is a target of the authentication processing is not falsified, that is, the authentication of the authentication program.

The mother board 40 has a main CPU (controller) 41, a ROM (Read Only Memory) 42, a RAM (Random Access Memory) 43, and a communication interface 44.

The main CPU 41 has a function of a controller for controlling the entire slot machine 10. In particular, the main CPU 41 carries out a control for outputting a command signal for rotating each stepping motor 70 to a motor driving circuit 62 when the credit is bet and the spin button 23 is pressed, a control for determining a symbol to be stopped at a position of the display window 15 (on the payline L) after the reel 14 is set in the scrolling state, and a control for stopping the reel 14 such that the determined symbol will be stopped at the position of the display window 15. Namely, the main CPU 41 has a function of an arrangement controller which, after a plurality of symbols displayed at the display are scrolled, selects and determines symbols to be arranged into a symbol matrix from plural types of symbols, and executes an arrangement control for stopping the scrolling state at the determined symbols, in order to rearrange them into a new symbol matrix.

The Main CPU 41 has a function of a stop switch controller which sets the stop switch 82 active when the specific combination is rearranged on the payline L that is set with respect to the symbol matrix, and enables the rearrangement to the first winning combination (“PLUM-PLUM-PLUM” for example) or the second winning combination (“PLUM-PLUM-MELON” for example) that is determined by the arrangement controller, in relation to the input timing of the stop switch 82 by the player.

The ROM 42 stores programs such as BIOS (Basic Input/Output System) to be executed by the main CPU 41, as well as data to be used permanently. When the BIOS is executed by the main CPU 41, the processing for initializing each peripheral device is carried out and the processing for reading the game program and the game system program stored in the memory card 53 through the gaming board 50 is started.

The RAM 43 stores data and programs to be used when the main CPU 41 carries out the processing.

The communication interface 44 carries out communications with the host computer or the like that is provided inside the gaming facility through a communication channel.

To the Mother board 40, a main body PCB (Printed Circuit Board) 60 and a door PCB 80 to be described below are connected through the respective USB (Universal Serial Bus). Also, a power source unit 45 is connected to the mother board 40. When the power is supplied from the power source unit 45 to the mother board 40, the main CPU 41 of the mother board 40 is activated, and the power is supplied to the gaming board 50 through the PCI bus and the CPU 51 is activated.

To the main body PCB 60 and the door PCB 80, devices for generating input signals to be inputted into the main CPU 41 and devices whose operations are to be controlled by control signals outputted from the main CPU 41 are connected. The main CPU carries out the calculation processing and stores its result into the RAM 43 by executing the game program and the game system program stored in the RAM 43 according to the input signals inputted into the main CPU 41, and carries out the processing for transmitting control signals to each device as the control processing with respect to each device.

To the main body PCB 60, a lamp 30, a sub CPU 61, a hopper 66, a coin detection unit 67, a graphic board 68, a speaker 29, a touch panel 69, a bill validator 22, a ticket printer 35, a card reader 36, a key switch 38S, and a data display 37 are connected. To the main body PCB 60, a stop switch 82, and a display lamp 83 provided in correspondence to the stop switch 82 are also connected.

The lamp 30 is controlled to be turned on or off according to the control signal outputted from the main CPU 41.

The sub CPU 61 carries out the control for rotating or stopping the reels 14 (14L, 14C, 14R). To the sub CPU 61, a motor driving circuit 62 having an FPGA (Field Programmable Gate Array) 63 and a driver 64 is connected. The FPGA 63 is an electronic circuit such a programmable LSI, which functions as a control circuit of the stepping motors 70. The driver 64 functions as an amplifier circuit for the pulses to be inputted into the stepping motors 70.

To the motor driving circuit 62, the stepping motors 70 (70L, 70C, 70R) for rotating the reels 14 are connected. In the present embodiment, the 1-2 phase excitation type stepping motors are used as the stepping motors 70.

To the sub CPU 61, an index detection circuit 65 and a position change detection circuit 71 are connected. The index detection circuit 65 detects a position of the rotating reel 14 (index to be described below), and is also capable of detecting the misalignment of the reel 14. The control for rotating or stopping the reels 14 will be described in detail below with references to the drawings.

The position change detection circuit 71 detects a change of the stopping position of the reel 14 after the rotation of the reel 14 is stopped. For example, the position change detection circuit 71 detects the change of the stopping position of the reel 14, in the case where the stopping position of the reel 14 is changed such that the arrangement of symbols are forcefully made by the player into the winning combination associated with the payout, even though the arrangement of symbols was actually not the winning combination associated with the payout.

The hopper 66 is provided inside the cabinet 11, and pays the prescribed number of coins according to the control signal outputted from the main CPU 41, from a coin payout opening 19 to a coin tray 18. The coin detection unit 67 is provided inside the coin payout opening 19, and outputs an input signal with respect to the main CPU 41 when it is detected that the prescribed number of coins are paid from the coin payout opening 19.

The graphic board 68 controls the image display on the upper side image display panel 33 and the lower side image display panel 16 according to the control signal outputted from the main CPU 41. On the credit amount display unit 31 of the lower side image display panel 16, the credit amount stored in the RAM 43 is displayed. On the payout amount display unit 32 on the lower side image display panel 16, the number of coins to be paid is displayed. The graphic board 68 has a VDP (Video Display Processor) for generating image data according to the control signal outputted from the main CPU 41 and a video RAM for temporarily storing the image data generated by the VDP.

The bill validator 22 reads an image of the bill and accepts the legitimate bill into the cabinet 11. The bill validator 22 outputs an input signal with respect to the main CPU 41 according to the amount of that bull when the legitimate bill is accepted. The main CPU 41 stores the credit amount according to the amount of the bill notified by that input signal into the RAM 43.

The ticket printer 35 prints the bar code which encodes data such as the credit amount stored in the RAM 43, the date and time, and the identification number of the slot machine 10, etc., on the ticket, according to the control signal outputted from the main CPU 41, and outputs it as the bar code attached ticket 39.

The card reader 36 reads data from the smart card and transmit it to the main CPU 41, or writes data into the smart card according to the control signal outputted from the main CPU 41. The key switch 38S is provided on the key pad 38, and outputs an input signal to the main CPU 41 when the key pad 38 is operated by the player.

The data display 37 displays the data read by the card reader 36 or the data inputted by the player through the key pad 38, according to the control signal outputted from the main CPU 41.

The stop switch 82 is a button for stopping the rotating right reel 14R when the stop control game to be described below is executed. As will be described below, when a transition to the stop control game is made, the stop switch 82 is set active, and the display lamp 83 is lit. Then, the main CPU 41 carries out a control to stop the rotating right reel 14R at a timing of the pressing of the stop switch 82 by the player.

To the door PCB 80, a control panel 20, a reverter 21S, a coin counter 21C and a cold cathode tube 81 are connected. On the control panel 20, a spin switch 23S corresponding to a spin button 23, a change switch 24S corresponding to a change button 24, a cashout switch 25S corresponding to a cashout button 25, a 1-BET switch 26S corresponding to a 1-BET button 26, and a max BET switch 27S corresponding to a max BET button 27 are provided. Each one of the switches 23S to 27S outputs an input signal with respect to the main CPU 41 when the corresponding one of the buttons 23-27 is operated by the player.

The coin counter 21C is provided inside the coin slot 21, and validates whether coins entered at the coin slot 21 are legitimate ones or not. Those coins that are not the legitimate ones will be ejected from the coin payout opening 19. The coin counter 21C outputs an input signal with respect to the main CPU 41 when the legitimate coins are detected.

The reverter 21S is operated according to a control signal outputted from the main CPU 41, to distribute the coins recognized as the legitimate coins by the coin counter 21C to the cash box (not shown) provided inside the slot machine 10 or the hopper 66. Namely, when the hopper 66 is filled with coins, the legitimate coins are distributed to the cash box by the reverter 21S. On the other hand, when the hopper 66 is not filled with coins, the legitimate coins are distributed to the hopper 66.

The cold cathode tube 81 functions as the background light provided on the back side of the lower side image display panel 16 and the upper side image display panel 33, and it is turned on according to a control signal outputted from the main CPU 41.

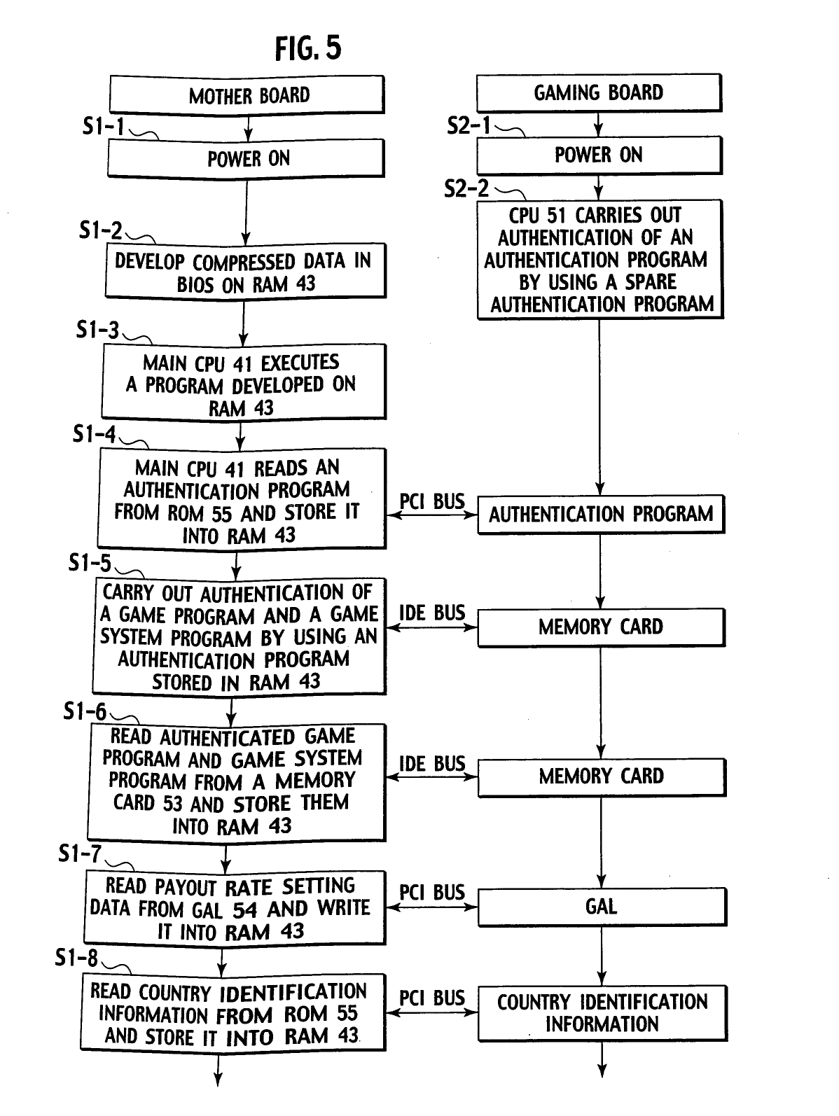

Next, the concrete processing to be carried out at the slot machine 10 will be described. FIG. 5 is a flow chart showing a procedure of the authentication and reading processing for the game program and the game system program (processing at the step S100 shown in FIG. 1), by the mother board 40 and the gaming board 50 shown in FIG. 4. Here it is assumed that the memory card 53 is attached to the card slot 53S and the GAL 54 is attached to the IC socket 54S on the gaming board 50.

First, when the power switch is turned on at the power source unit 45, the mother board 40 and the gaming board 50 are activated (steps S1-1, S2-1). When the mother board 40 and the gaming board 50 are activated, the respective independent processings will be carried out in parallel. Namely, at the gaming board 50, the CPU 51 carries out the reading of the spare authentication program stored in the boot ROM 52, and the spare authentication for checking and verifying that the authentication program is not falsified in advance, according to the read out spare authentication program, before it is taken into the mother board 40 (step S2-2).

On the other hand, at the mother board 40, the main CPU 41 executes the BIOS stored in the ROM 42 and expands the compressed data incorporated in the BIOS over the RAM 43 (step S1-2). Then, the main CPU 41 executes the BIOS expanded on the RAM 43 to carry out the diagnosis and initialization of various types of peripheral devices (step S1-3).

Then, as the ROM 55 of the gaming board 50 is connected to the main CPU 41 through the PCI bus, the main CPU 41 carries out the reading of the authentication program stored in the ROM 55. The main CPU 41 carries out the processing for storing the read out authentication program into the RAM 43 (step S1-4).

Next, the main CPU 41 makes an access to the memory card 53 that is attached to the card slot 53S through the IDE bus. Then, the main CPU 41 carries out the reading of the game program and the game system program stored in the memory card 53.

Next, the main CPU 41 carries out the authentication for checking and verifying that the read out game program and game system program are not falsified, according to the authentication program stored in the RAM 43 (step S1-5).

When this authentication processing is finished normally, the main CPU 41 stores the authenticated game program and game system program into the RAM 43 (step S1-6). Next, the main CPU 41 makes an access to the GAL 54 that is attached to the IC socket 54S through the PCI bus, reads out the payout rate setting data from the GAL 54, and stores it into the RAM 43 (step S1-7). Next, the main CPU 41 carries out the reading of the country identification information stored in the ROM 55 of the gaming board 50, and stores the read out country identification information into the RAM 43 (step S1-8).

After carrying out the above described processing, the main CPU 41 sequentially reads out and executes the game program and the game system program, to proceed with the base game as described below.

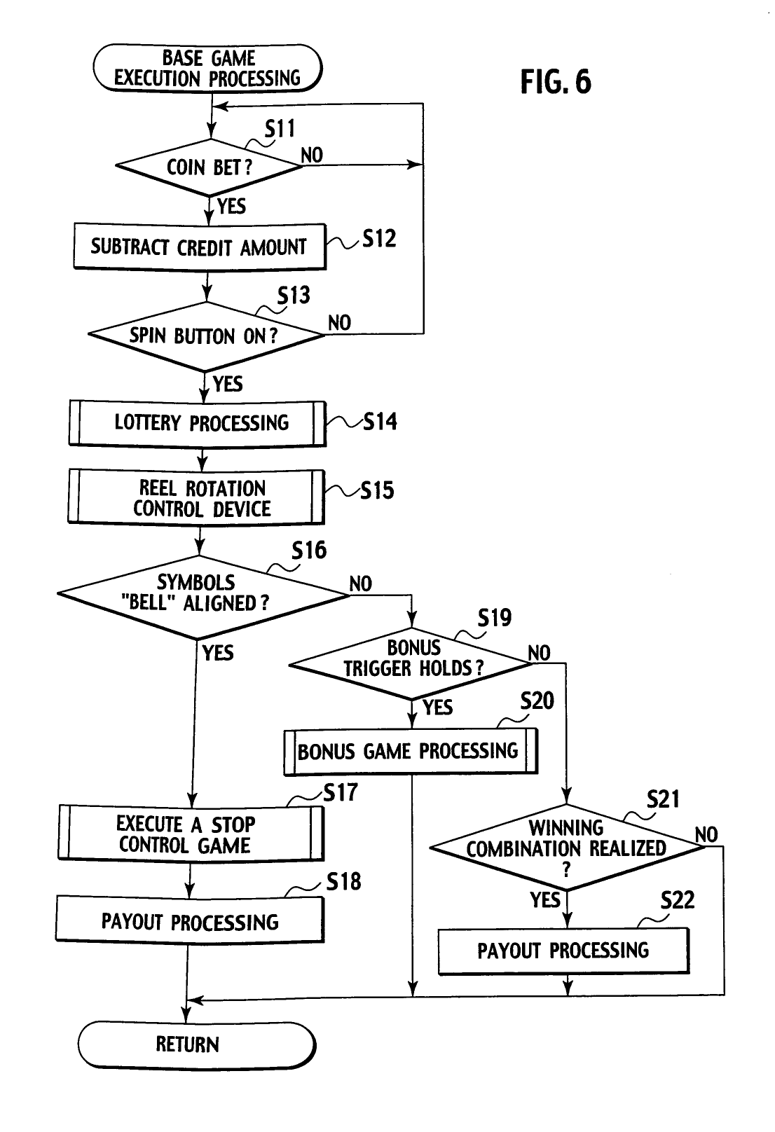

After the authentication and reading processing shown in FIG. 5 is carried out, the main CPU 41 carries out the base game execution processing. FIG. 6 is a flow chart showing the concrete processing procedure of the base game execution processing shown at the step S200 of FIG. 1.

In the base game execution processing, first, the main CPU 41 judges whether the coin BET has been made or not (step S11). In this processing, the main CPU 41 judges whether the input signal outputted from the 1-BET switch 26S when the 1-BET button 26 is pressed or the input signal outputted from the max BET switch 27S when the max BET button 27 is pressed has been received or not. When it is judged that the coin BET has not been made, the processing returns to the step S11.

On the other hand, at the step S11, when it is judged that the coin BET has been made, the main CPU 41 carries out the processing for subtracting the credit amount stored in the RAM 43 according to the number of coins to be bet (step S12). When the number of coins to be bet is greater than the credit amount stored in the RAM 43, the processing is returned to the step S11, without carrying out the processing for subtracting the credit amount stored in the RAM 43. When the number of coins to be bet exceeds the upper limit value (50 in the present embodiment) that can be bet per one game, the processing proceeds to the step S13, without carrying out the processing for subtracting the credit amount stored in the RAM 43. In this state, the reels 14 (14L, 14C, 14R) are set in a state where it is possible to start the rotation.

Next, the main CPU 41 judges whether the spin button 23 is turned ON or not (step S13). In this processing, the main CPU 41 judges whether the input signal outputted from the spin switch 23S when the spin button 23 is turned ON is received or not.

When it is judged that the spin button 23 is not turned ON, the processing is returned to the step S11. In the case where the spin button 23 is not turned ON (the case where a command indicating the finishing of the game is inputted without turning the spin button 230N, for example), the main CPU 41 cancels the subtraction result at the step S12.

In the present embodiment, the exemplary case of carrying out the processing for subtracting the credit amount (step S12) after the coin BET is made (step S11), before making the judgement as to whether the spin button 23 is turned ON or not (step S13) will be described. However, the present invention is not limited to this exemplary case. For example, it is also possible to make the judgement as to whether the spin button 23 is turned ON or not (step S13) after the coin BET is made (step S11), and carry out the processing for subtracting the credit amount (step S12) when it is judged that the spin button 23 is turned ON (step S13 YES).

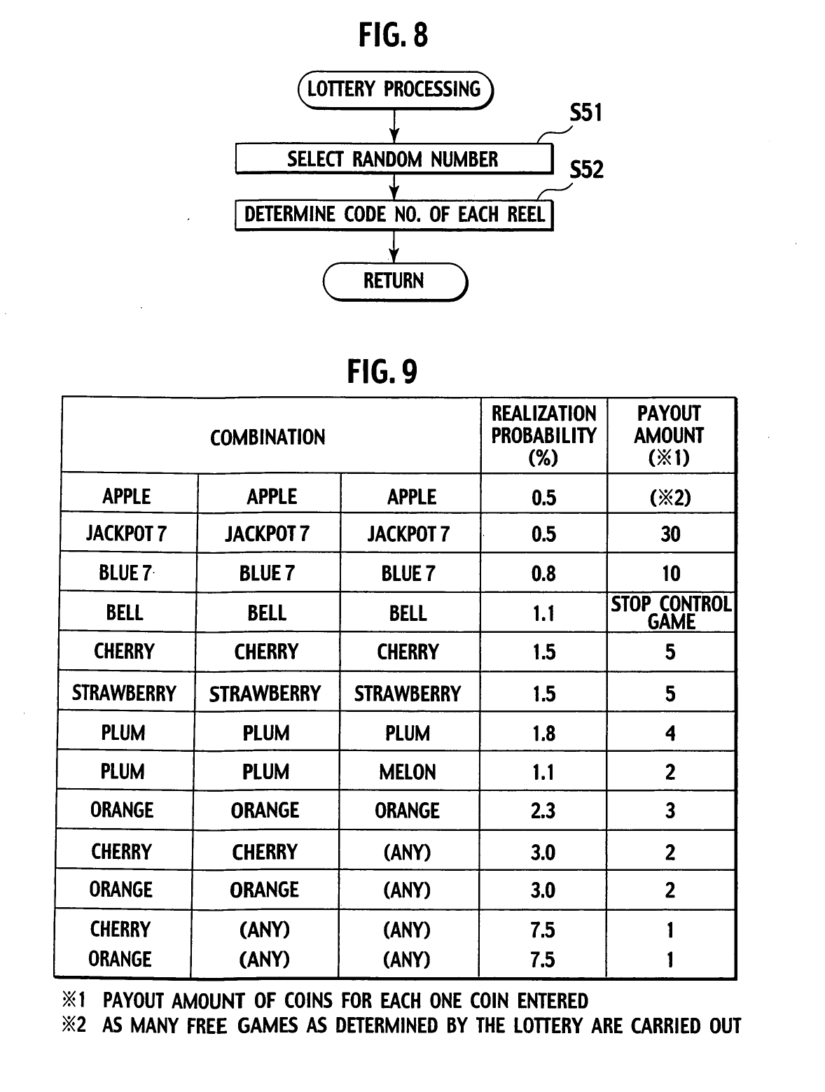

Then, at the step S13 of FIG. 6, when it is judged that the spin button 23 is turned ON, the main CPU 41 carries out the lottery processing (step S14). In this lottery processing, the main CPU 41 determines code numbers at a time of stopping the reels 14 (14L, 14C, 14R) by executing the lottery program stored in the RAM 43. In this way, the combination of symbols to be stopped on the payline L is determined. This processing will be described in further detail below with reference to FIG. 8. In the present embodiment, the exemplary case of determining one winning combination from a plurality of winning combinations by determining the combination of symbols to be displayed at a time of stopping will be described, but in the present invention, it is also possible to determine one winning combination selected from a plurality of winning combinations by the lottery first, and then determine the combination of symbols to be stopped according to the above described winning combination, for example.

Next, the main CPU 41 carries out the reel rotation control processing (step S15). This processing is a processing for stopping the rotation of the reels 14 after the rotation of all the reels 14 (14L, 14C, 14R) is started, such that the arrangement of symbols corresponding to the winning combination determined at the step S14 will be stopped on the payline L.

Next, the main CPU 41 judges whether the specific symbols “BELL” are aligned on the payline L or not (step S16: corresponding to the step S300 of FIG. 1). Namely, whether the symbols “BELL-BELL-BELL” has been won by the above described lottery processing and the symbols “BELL-BELL-BELL” has been stopped on the payline L by the reel rotation control processing or not is judged.

When it is judged that the symbols “BELL-BELL-BELL” are not aligned on the payline L (step S16 NO), the main CPU 41 judges whether the symbols that are the bonus trigger are aligned on the payline L or not (step S19). More specifically, as shown in FIG. 9 to be described below, whether the symbols “APPLE-APPLE-APPLE” that are the bonus trigger are stopped on the payline L or not is judged.

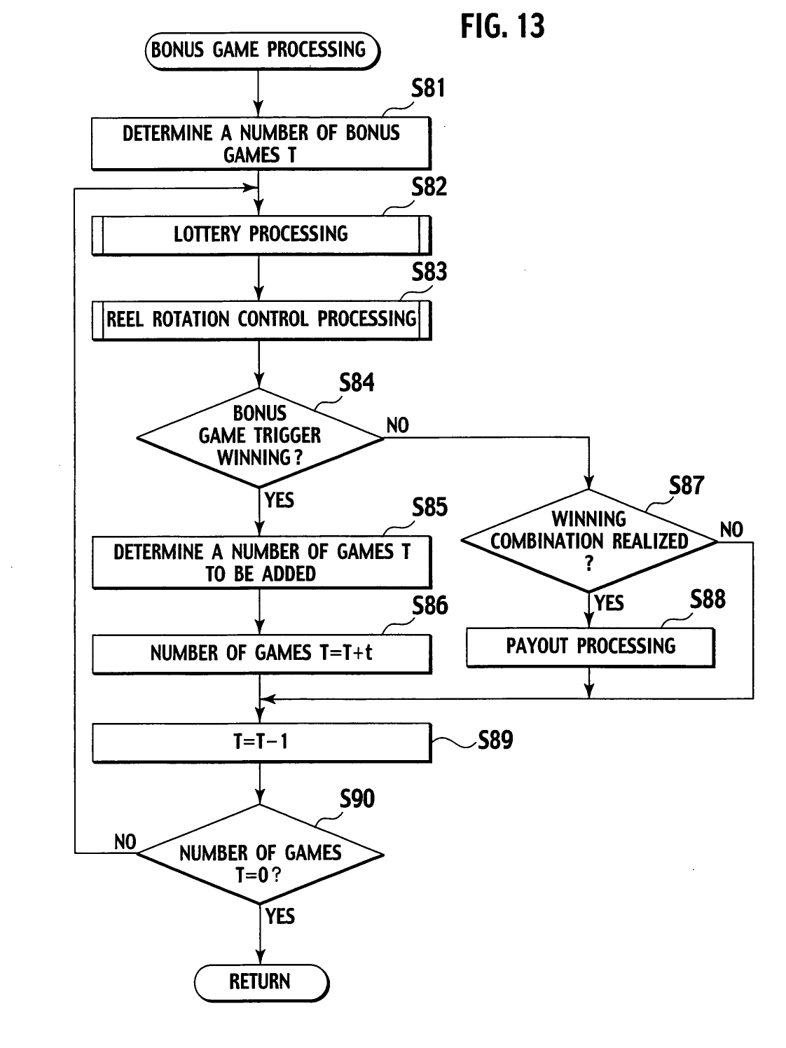

When it is judged that the bonus trigger is realized (step S19 YES), the main CPU 41 executes the bonus game processing (step S20). The detailed processing procedure of the bonus game processing will be described below with reference to FIG. 13.

When it is judged that the bonus trigger is not realized (step S19 NO), the main CPU 41 judges whether the winning combination is realized by the symbols stopped on the payline L or not (step S21). When it is judged that the winning combination is realized (step S21 YES), the main CPU 41 executes the processing for paying the number of coins corresponding to this winning combination (step S22). The correspondence relationship between the winning combination and the number of coins to be paid is shown in FIG. 19 to be described below. For example, in the case where the winning combination “CHERRY-CHERRY-CHERRY” is realized, the payout of five coins for each one coin entered will be made.

In the case of depositing the paid coins, the main CPU 41 adds the prescribed amount of credit to the credit amount stored in the RAM 43. In the case of paying the coins, the main CPU 41 makes the payout of a prescribed number of coins by transmitting the control signal to the hopper 66. At this point, the coin detection unit 67 counts the number of coins paid from the hopper 66, and transmits a payout completion signal to the main CPU 41 when the count value reached the specified number. As a result, the main CPU 41 stops the driving of the hopper 66 and finishes the coin payout processing.

When the main CPU 41 judges that the winning combination is not realized (step S21 NO), the payout of coins will not be made. Namely, it will be a lost game.

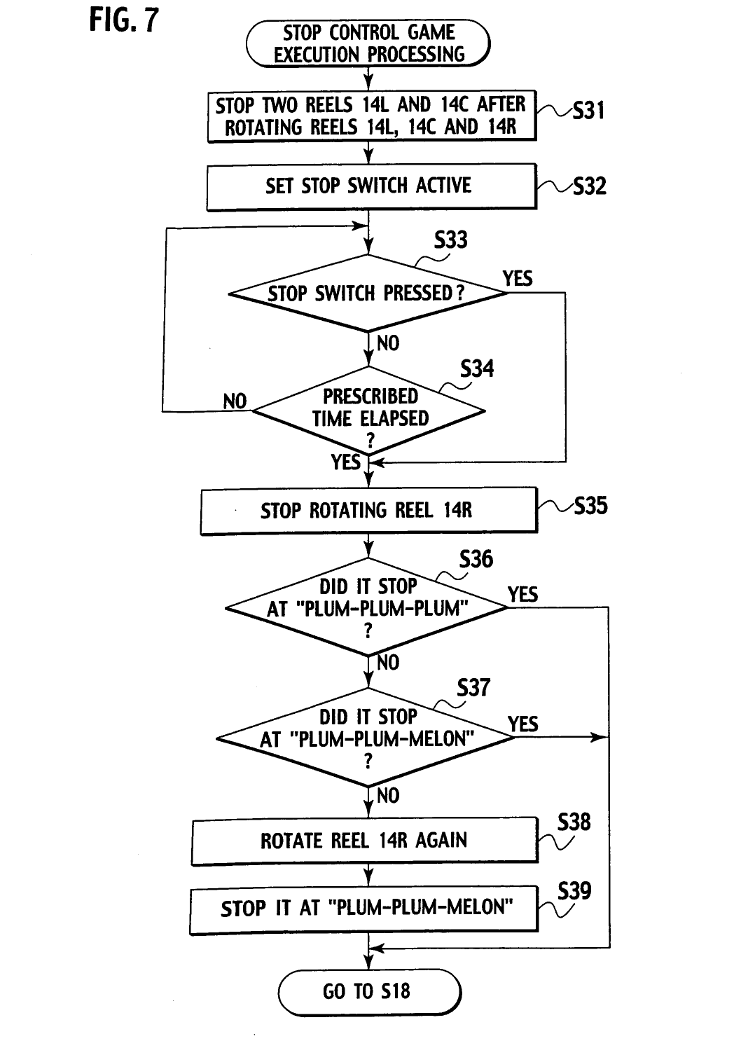

On the other hand, in the processing of the step S16, when the main CPU 41 judges that the symbols “BELL-BELL-BELL” are stopped on the payline L (step S16 YES), the main CPU 41 executes the stop control game (step S17: corresponding to the step S400 of FIG. 1). The stop control game is a game for stopping the rotating reels 14 in relation to the operation of the stop switch 82 by the player, and its details will be described below with reference to the flow chart shown in FIG. 7.

When the stop control game is finished, the main CPU 41 makes the payout of coins corresponding to the winning combination that is stopped on the payline L by this stop control game (step S18: corresponding to the step S600 shown in FIG. 1).

Next, the processing procedure of the stop control game shown at the step S17 of FIG. 6 will be described.

FIG. 7 is a flow chart showing the processing procedure of the stop control game. In the stop control game, the main CPU 41 rotates the reels 14 without requiring the entering of the coins or the consumption of the credit. The main CPU 41 rotates the reels 14 (14L, 14C, 14R), and then stops the left reel 14L and the center reel 14C at the symbol “PLUM” (step S31). At this point, the rotation of the right reel 14R is continued.

Next, the main CPU 41 sets the stop switch 82 shown in FIG. 2 active (step S32). Namely, it is set in a state where the rotating right reel 14R can be stopped by pressing the stop switch 82 (step S32).

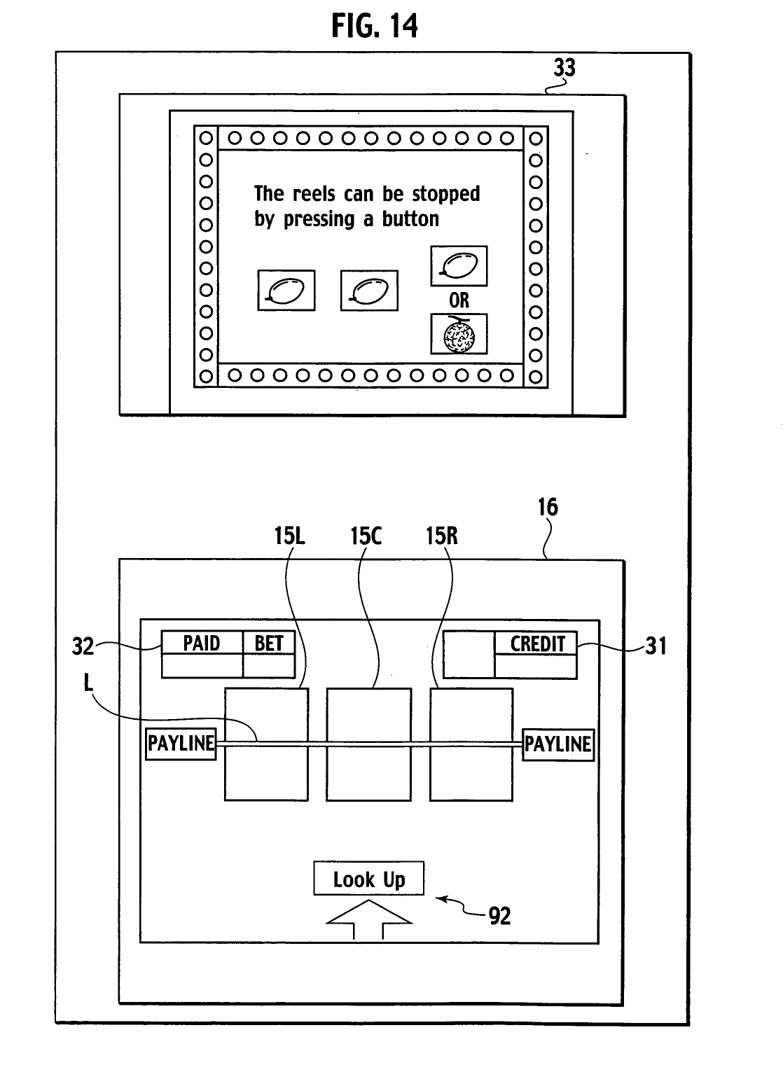

At this point, in order to notify that the operation of the stop switch 82 is possible to the player, as shown in FIG. 14, the letters of “The reel can be stopped by pressing a button” and the pictures for notifying that the symbols that can be stopped on the payline L are “PLUM-PLUM-PLUM” or “PLUM-PLUM-MELON” will be displayed on the upper side image display panel 33 of the slot machine 10. Namely, from the left side, the picture of “PLUM”, the picture of “PLUM”, and the picture of “PLUM” or “MELON” are displayed. Moreover, the main CPU 41 carries out a control to turn the display lamp 83 on.

Next, the main CPU 41 judges whether the stop switch 82 is pressed or not (step S33). When the stop switch 82 is pressed, the main CPU 41 stops the rotating right reel 14R (step S35).

In this case, the main CPU 41 stops the right reel 14R when it is detected that the stop switch 82 is pressed by receiving the detection signal of the detection sensor (not shown) provided at the stop switch 82.

The main CPU 41 controls the stopping position of the right reel 14R such that the symbols “PLUM” and “MELON” can be stopped on the payline L provided at the display position of the right display window 15R. Namely, it is set in a state where it is possible to rearrange the scrolled symbols into either the first winning combination or the second winning combination.

Consequently, in the case where the stop switch 82 is pressed by the player when the symbol “PLUM” displayed on the side face of the rotating right reel 14R exists on the payline L or exists in a vicinity on the upper side of the payline L, the symbol “PLUM” will be stopped on the payline L at the right reel 14R (step S36 YES). In this case, as shown in FIG. 9 to be described below, the main CPU 41 makes the payout of four coins for each one coin entered. Namely, in the case where the first winning combination “PLUM-PLUM-PLUM” is stopped on the payline L, the payout of four coins for each one coin entered that is set as the prescribed number of coins will be made.

Similarly, in the case where the stop switch 82 is pressed by the player when the symbol “MELON” displayed on the side face of the rotating right reel 14R exists on the payline L or exists in a vicinity on the upper side of the payline L, the symbol “MELON” will be stopped on the payline L at the right reel 14R (step S37 YES). In this case, as shown in FIG. 9 to be described below, the main CPU 41 makes the payout of two coins for each one coin entered. Namely, in the case where the second winning combination “PLUM-PLUM-MELON” is stopped on the payline L, the payout of two coins for each one coin entered, which is less than the payout of four coins for each one coin entered that is set as the above described prescribed number of coins, will be made. Consequently, the player can obtain the greater amount of payout by stopping the reel at the symbol “PLUM” than stopping the reel at the symbol “MELON”, at a time of stopping the right reel 14R.

On the other hand, when the symbol “PLUM” or “MELON” of the right reel 14R cannot be stopped on the payline L, that is, when a position on the right reel 14R that exists on the payline L at a time the stop switch 82 is pressed by the player is not in vicinity of the symbol “PLUM” or “MELON”, the symbol “PLUM” or “MELON” cannot be stopped on the payline L and the symbol other than “PLUM” and “MELON” will be stopped (step S37 NO).

In this case, the main CPU 41 invalidates the operation by the stop switch 82, rotates the right reel 14R again (step S38), and after a prescribed time has elapsed, stops the right reel 14R at the symbol “MELON”. In other words, the symbols “PLUM-PLUM-MELON” (the second winning combination) will be stopped on the payline L (step S39). Then, the processing proceeds to the step S18 shown in FIG. 6. At the step S18 of FIG. 6, the main CPU 41 carries out the processing for paying coins according to the winning combination that is stopped on the payline L.

In this way, in the stop control game, when the player stops the right reel 14R by pressing the stop switch 82 and the right reel 14R is stopped at the symbol “PLUM”, four coins for each one coin entered will be paid. When the right reel 14R is stopped at the symbol “MELON”, two coins for each one coin entered will be paid. When the right reel 14R is stopped at the symbol other than “PLUM” and “MELON”, the right reel 14R is rotated again and automatically stopped at the symbol “MELON”, and two coins for each one coin entered will be paid.

Next, the lottery processing shown at the step S14 of FIG. 6 will be described with reference to a flow chart shown in FIG. 8.

FIG. 8 is a flow chart showing a procedure of the lottery processing shown at the step S14 of FIG. 6. This processing is a processing to be carried out as the main CPU 41 executes the lottery program stored in the RAM 43.

First, the main CPU 41 selects the random number values corresponding to the three reels 14 (14L, 14C, 14R) from the numerical value range of 0 to 255, by executing the random number generation program contained in the lottery program (step S51).

Next, the main CPU 41 refers to the symbol weighing data according to the payout rate setting data outputted from the GAL 54 and stored in the RAM 43, and determines the code numbers (see FIG. 3) for the reels 14 according to the selected three random number values (step S52). The code numbers of the reels 14 (14L, 14C, 14R) correspond to the code numbers of the symbols to be displayed at a time of being stopped on the payline L. The main CPU 41 determines the winning combination by determining the code numbers of the reels 14, For example, when the code numbers of the reels 14 (14L, 14C, 14R) are determined as “00”, “00” and “00”, the main CPU 41 has determined “JACKPOT 7” as the winning combination. According to the code numbers of the reels, the reel rotation control processing to be described below will be carried out.

Here, the winning combination in the present embodiment will be described. FIG. 9 is a diagram for explaining a plurality of winning combinations in the present embodiment, and the relationship of the realization probability and the payout amount of each winning combination. The realization probability of each winning combination shown in FIG. 9 is for the case where the payout rate of games other than the bonus game is 88%.

The realization probability of the symbols “APPLE-APPLE-APPLE” which are the bonus game trigger is 0.5%. When the bonus trigger is realized, the bonus game is executed, and as many numbers of free games as determined by the lottery will be executed in the present embodiment.

The realization probability of “JACKPOT 7” is 0.5%. When this winning combination is realized, three symbols “JACKPOT 7” will be stopped on the payline L. Then, the payout of 30 coins for each one coin entered will be made. The payout amount is set to be greater for the winning combination with the lower realization probability. In the case there the symbols that do not correspond to any of the winning combinations shown in FIG. 9 are stopped, it is a lost game, and the payout of coins will not be made.

When the winning combination “BELL-BELL-BELL” is stopped on the payline L, the stop control game described above will be executed. In the present embodiment, the exemplary case of using the combination of symbols “BELL-BELL-BELL” as the combination for making a transition to the stop control game is described, but it is also possible to use the combination of symbols other than that. It is also possible to set a plurality of combinations of symbols for making a transition to the stop control game.

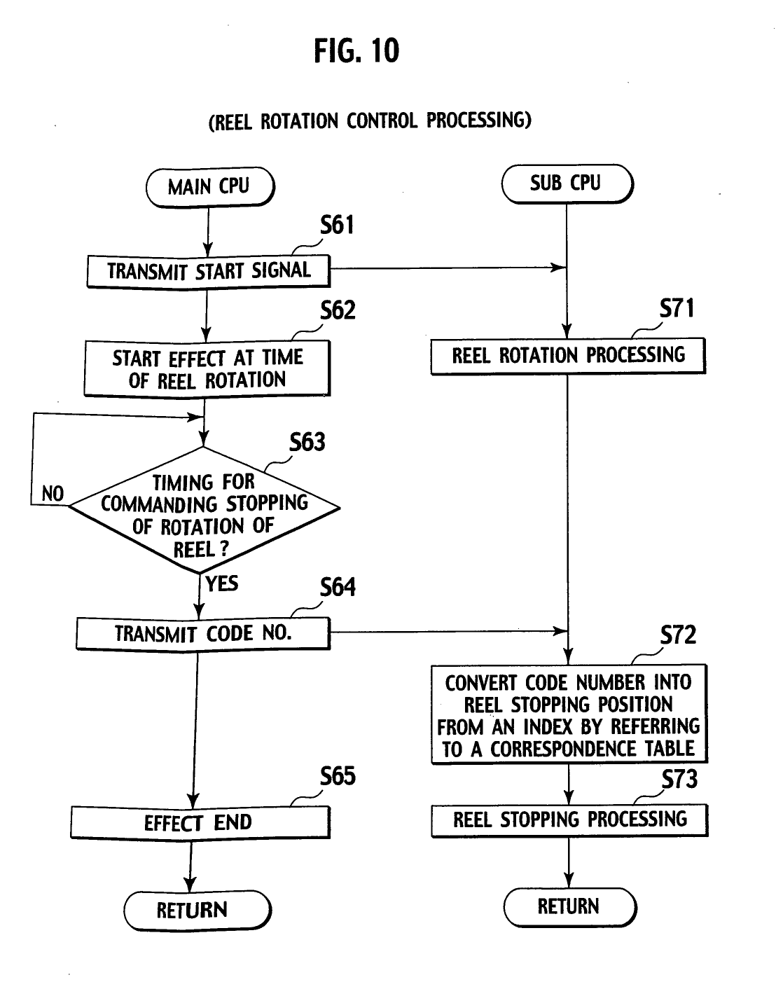

FIG. 10 is a flow chart showing the reel rotation control processing shown at the step S15 of FIG. 6. Note that this processing is a processing carried out between the main CPU 41 and the sub CPU 61.

First, the main CPU 41 transmits a start signal indicating that the rotation of the reels 14 will start, to the sub CPU 61 (step S61). Upon receiving the start signal from the main CPU 41, the sub CPU 61 carries out the reel rotation processing (step S71). In this processing, the sub CPU 61 supplies pulses to the motor driving circuit 62. The pulses outputted from the sub CPU 61 are amplified by the driver 64, and supplies to the stepping motors 70 (70L, 70C, 70R). As a result, the stepping motors 70 are rotated and in conjunction with that, the reels 14 (14L, 14C, 14R) are rotated. The stepping motor 70 of the 1-2 phase excitation type has the step angle of 0.9o and the number of steps is 400 steps per one rotation. Consequently, when 400 pulses are supplied to the stepping motor 70, the reel 14 is rotated once.

At a time of start rotating the reels 14, the sub CPU 61 supplies low frequency pulses to the motor driving circuit 62, and gradually raises the frequency of the pulses. In conjunction with that, the rotation speed of the reels 14 is increased. Then, after a prescribed time has elapsed, the frequency of the pulses is made constant. As a result, the reels 14 are rotated at a constant speed.

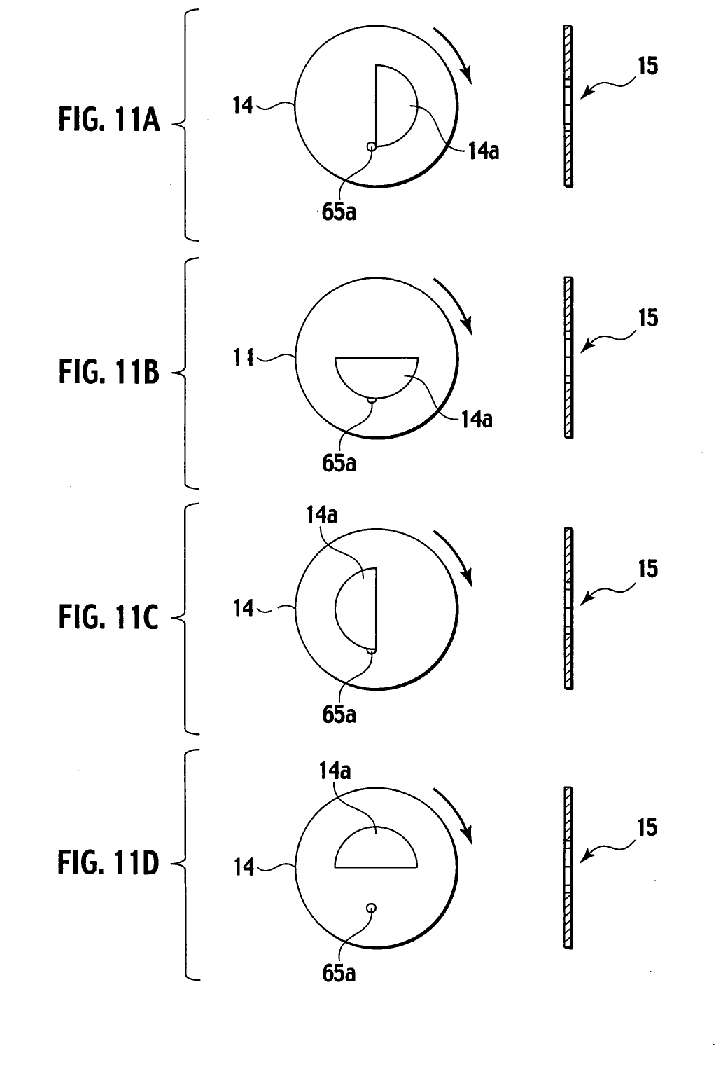

Here, the rotation operation of the reel 14 will be described with references to FIG. 11A to FIG. 11D. FIG. 11A to FIG. 11D are diagrams for explaining the rotation operation of the reel 14.

As shown in FIG. 11A, on the side face of the reel 14, a metal plate 14a of a semicircular shape is provided. The metal plate 14a is rotated along with the reel 14. On the circumferential surface of the reel 14, 22 symbols are displayed (see FIG. 3). Among the 22 symbols displayed on the circumferential surface of the reel 14, three symbols will be visible from the player through the display window 15 formed on a front side of the reel 14. In FIGS. 11A to 11D, the arrow indicates a direction of the rotation of the reel 14. On the side face of the reel 14, a proximity sensor 65a is provided. The proximity sensor 65a detects the metal plate 14a. The proximity sensor 65a will not be moved or rotated even while the reel 14 is rotated.

FIG. 11A shows a position of the metal plate 14a (referred also as a position A hereafter) at a timing at which the proximity sensor 65a starts to detect the metal plate 14a. When the reel 14 is rotated while the metal plate 14a is located at the position A, the metal plate 14a moves to a position shown in FIG. 11B. FIG. 11B shows a position of the metal plate 14a (referred also as a position B hereafter) while the proximity sensor 65a is detecting the metal plate 14a. When the reel 14 is rotated while the metal plate 14a is located at the position B, the metal plate 14a moves to a position shown in FIG. 11C. FIG. 11C shows a position of the metal plate 14a (referred also as a position C hereafter) at a timing at which the proximity sensor 65a stops detecting the metal plate 14a.

When the reel 14 is rotated while the metal plate 14a is located at the position C, the metal plate 14a moves to a position shown in FIG. 11D. FIG. 11D shows a position of the metal plate 14a (referred also as a position D hereafter) while the proximity sensor 65a is not detecting the metal plate 14a. When the reel 14 is rotated further, the position of the metal plate 14a returns to the position A. As described above, in conjunction with the rotation of the reel 14, the position of the metal plate 14a changes in an order of the position A, the position B, the position C, the position D, the position A, and so on.

The proximity sensor 65a constitutes the index detection circuit 65 (see FIG. 4). By denoting a state in which the proximity sensor 65a is detecting the metal plate 14a as “High” and a state in which the proximity sensor 65a is not detecting the metal plate 14a as “Low”, the state of the index detection circuit 65 is “High” while the metal plate 14a is at the position A→the position B→the position C, and the state of the index detection circuit 65 is “Low” while the metal plate 14a is at the position C→the position D→the position A. The sub CPU 61 recognizes the rotation position of the reel 14 by setting the rise from “Low” to “High” as an index (origin) 1 and the fall from “High” to “Low” as an index (origin) 2.

After transmitting the start signal to the sub CPU 61 at the step S61 shown in FIG. 10, the main CPU 41 executes the effects at a time of the reel rotation (step S62). This processing is a processing for displaying the images on the lower side image display panel 16 and outputting sounds from the speaker 29, during a period ((three seconds, for example) determined according to the result of the lottery processing (step S14 of FIG. 6).

Next, the main CPU 41 judges whether it is a timing for commanding the stopping of the rotation of the reels 14 or not (step S63 of FIG. 10).

Here, the timing for commanding the stopping of the rotation of the reels 14 is a timing which is earlier than a timing at which the effects at a time of the reel rotation is to be finished, by a minimum necessary time for stopping the rotation of the reels 14.

When it is judged that it is not a timing for commanding the stopping of the rotation of the reels 14 at the step S63, the processing is returned to the step S63 and the effects at a time of the reel rotation are continued. When it is judged that it is a timing for commanding the stopping of the rotation of the reels 14 at the step S63, the main CPU 41 transmits the code numbers of the reels stored in the RAM 43 to the sub CPU 61 (step S64). Upon receiving the code numbers of the reels from the main CPU 41, the sub CPU 61 converts the code number into the reel stopping position (the number of steps) from the index, according to a correspondence table of the number of steps and the code number that is stored in a ROM (not shown) provided at the sub CPU 61 (step S72).

FIG. 12 is a diagram showing the correspondence table of the number of steps and the code number, where the index and the number of steps are set in correspondence to each code number.

In FIG. 12, each code number corresponds to the symbol depicted on the outer circumferential surface of the reel 14 (see FIG. 3), and the symbols of the code numbers “00” to “10” correspond to the index 1 while the symbols of the code numbers “11” to “21” correspond to the index 2. The number of steps in the correspondence table shown in FIG. 12 is the number of steps with reference to the index 1. For example, when the code number is “08”, the reel stopping position is 145 steps from the index 1, and when the code number is “12”, the reel stopping position is 218 steps from the index 1.

Next, the sub CPU 61 executes the reel stopping processing (step S73). In this processing, the sub CPU 61 detects the rise (index 1) from “Low” to “High” at the index detection circuit 65 for each reel 14, supplies pulses corresponding to the number of steps converted from the code number at the step S52 at a timing of detecting the index 1, and then stops the supply of pulses.

For example, at the step S72 of FIG. 10, when it is determined that the reel stopping position is 145 steps from the index 1, the sub CPU 61 supplies 145 pulses to the motor driving circuit 62 at a timing of detecting the index 1. and then stops the supply of pulses. When it is determined that the reel stopping position is 218 steps from the index 1 at the step S72, the sub CPU 61 supplies 218 pulses to the motor driving circuit 62 at a timing of detecting the index 1. As a result, the reel 14 will be stopped as indicated by the code number determined at the step S72 of FIG. 10, and the combination of symbols corresponding to the winning combination determined at the step S72 of FIG. 10 will be stopped on the payline L. On the other hand, the main CPU 41 finishes the effects at a time of the reel rotation. After finishing the processing of the steps S65 and S73, the present processing is finished.

In the case where the index corresponding to the code number transmitted at the step S64 is different from the index detected by the index detection circuit 65 when the rotation of the reel 14 is stopped, it implies that the misalignment of the reel 14 has occurred, so that the main CPU 41 carries out the processing for displaying an error message on the lower side image display panel 16, and interrupts the game.

For example, in the case where the processing for stopping the left reel 14L by using the code number “12” corresponding to the index 2 is carried out, but the index 1 is detected by the index detection circuit 65 when the rotation of the left reel 14L is stopped, the game will be interrupted.

FIG. 14 shows exemplary images to be displayed on the upper side image display panel 33 and the lower side image display panel 16 when the stop control game is executed. On the lower part of the lower side image display panel 16, the image 92 showing an arrow pointing upwards and “Look Up” is displayed. The image 92 is an image for urging the player to look at the upper side image display panel 33.

On the upper side image display panel 33, letters “The reels can be stopped by pressing a button” and symbols “PLUM”, “PLUM”, and “PLUM” or “MELON” are displayed. By looking at this display, the player can recognize that the rotating reel 14R can be stopped by pressing the stop switch 82.

Next, the bonus game processing shown at the step S20 of FIG. 6 will be described. FIG. 13 is a flow chart showing the bonus game processing. In the bonus game processing, first, the main CPU 41 determines the number of games T of the bonus game to be any of 10 to 25 games, according to the random number value obtained by executing the random number generation program contained in the lottery program stored in the RAM 43 (step S81). The main CPU 41 stores the determined data on the number of games T of the bonus game into the RAM 43.

Next, the main CPU 41 carries out the lottery processing (step S82) and the reel rotation control processing (step S83). The processing of the step S82 is similar to the processing described above with reference to FIG. 8. The processing of the step S83 is similar to the processing described above with reference to FIG. 10. These processings have already been described above, so that their description will be omitted here.

Next, in FIG. 13, the main CPU 41 judges whether the bonus game trigger is realized or not, that is, whether the symbols “APPLE” are aligned on the payline L formed on the display windows 15 or not (step S84). When it is judged that the bonus game trigger is realized, the number t of repetitions of the bonus game is newly determined by the lottery (step S85), and the determined number t of repetitions is added to the current number of games T of the bonus game (step S86). In this way, when the bonus game is won again during the bonus game, the remaining number of the bonus games will be increased.

When the bonus game is not realized, the main CPU 41 judges whether the winning combination is realized or not (step S87). When it is judged that the winning combination is realized, the main CPU 41 makes the payout of coins according to the number of coins entered and the winning combination (step S88).

When the processing of the steps S86 and S88 is executed or when it is judged that any of the winning combinations is not realized at the step S87 (it is judged as a lost game), the main CPU 41 reads out the number of games T of the bonus game stored in the RAM 43, subtracts one from the read out number of games T, and stores the number of games T after the subtraction into the RAM 43 again (step S89).

Next, the main CPU 41 judges whether the number of executed bonus games has reached the number of games T determined at the step S81 or not (step S90). More specifically, it is judged by judging whether the number of games T stored in the RAM 43 has become zero or not, and when the number of games T is not zero, that is, when it is judged that the number of executed bonus games has not reached the number of games T determined at the step S81, the processing is returned to the step S82 and the above described processing is repeated.

On the other hand, when the number of games T is zero, that is, when it is judged that the number of executed bonus games has reached the number of games T determined at the step S81, the processing is finished.

As described above, in the slot machine and the gaming method using the slot machine according to the present embodiment, when the combination of symbols “BELL-BELL-BELL” (the specific combination) is stopped on the payline L, the stop control game in which the reels 14 can be stopped by the player by pressing the stop switch 82 will be executed. Then, in the stop control game, the two reels including the left reel 14L and the center reel 14C are stopped at the symbol “PLUM” while the right reel 14R continues to be rotated. When the player presses the stop switch 82, the rotating right reel 14R is stopped in relation to the timing of pressing.

At this point, the right reel 14R is set to be capable of being stopped at the symbol “PLUM” or “MELON”. When the right reel 14R is stopped at the symbol “PLUM”, the payout of four coins for each one coin entered is made, and when the right reel 14R is stopped at the symbol “MELON”, the payout of two coins for each one coin entered is made. Consequently, it is possible to provide the player with a new gaming aspect in which more coins can be obtained by stopping the reel at the symbol “PLUM”, so that it is possible to prevent the player from losing interests or attentions to the games.

Even in the case where it was not possible to stop the reel at either one of the symbols “PLUM” and “MELON”, the right reel 14R will be rotated again and automatically stopped at the symbol “MELON”, so that the winning combination “PLUM-PLUM-MELON” can be stopped on the payline L, and it is possible to obtain the payout of two coins for each one coin entered.

Consequently, the highly skilled player who can stop the reel at the symbol “PLUM” by operating the stop switch 82 can obtain the payout of four coins for each one coin entered, and even the player who is not skilled in operating the stop switch 82 can obtain the payout of two coins for each one coin entered at least. In other words, the highly skilled player has a higher possibility of obtaining more coins, so that it is possible to introduce the technicality into the game of the slot machine.

In the case where the transition to the stop control game is made, the message that the operation to stop the right reel 14R by the stop switch 82 is possible and the image 92 indicating the winning combination that can be stopped on the payline L are displayed on the upper side image display panel 33, so that the player can recognize the symbol at which it should be tried to stop by looking at this image 92.

In the above, the embodiment of the slot machine according to the present invention has been described, but it is only showing a concrete example which should not limit the present invention in any particular way, and the concrete configuration of each means or the like can be appropriately changed by design. Also, the effects described in the embodiment of the present invention are only listing the most preferable effects arising from the present invention, and the effects of the present invention are not limited to those described in the embodiment of the present invention.

What is claimed is:

1. A slot machine comprising a controller operable to, in a case of rearranging a plurality of symbols arranged on a display, when the symbols are rearranged into a specific combination, make a transition to a stop control game in which the symbols can be rearranged into a plurality of winning combinations according to a control input signal from an external.

2. The slot machine of claim 1, wherein the controller notifies those symbols that can be rearranged in the stop control game, to a player.

3. The slot machine of claim 1, wherein the controller determines two winning combinations into which the symbols can be rearranged in the stop control game, and rearranges the symbols into one of the two winning combinations when the symbols were not rearranged into either one of the two winning combinations as a result of playing the stop control game.

4. A slot machine comprising a controller operable to, in a case of rearranging a plurality of symbols arranged on a display, when the symbols are rearranged into a specific combination, make a transition to a stop control game in which, according to a control input signal from an external, the symbols can be rearranged into a first winning combination associated with a payout or a second winning combination associated with a less amount of payout than the first winning combination.

5. The slot machine of claim 4, wherein the controller notifies those symbols that form the first winning combination, to a player, at a time of making a transition to the stop control game.

6. The slot machine of claim 4, wherein the controller determines the first winning combination and the second winning combination into which the symbols can be rearranged in the stop control game, and rearranges the symbols into the second winning combination when the symbols were not rearranged into either one of the first winning combination and the second winning combination as a result of playing the stop control game.

7. A slot machine comprising:
a display on which a symbol matrix formed by a plurality of columns and a plurality of rows is to be arranged;
an arrangement controller operable to execute an arrangement control in which a plurality of symbols arranged on the display are scrolled and then rearranged into a new symbol matrix, by selectively determining those symbols to be arranged into the symbol matrix from a plurality of types of symbols and stopping scrolling at determined symbols;
a stop switch connected to the arrangement controller and operable by a player; and
a stop switch controller operable to set the stop switch active when the symbols are rearranged into a specific combination on a payline that is set with respect to the symbol matrix, and enable rearrangement of the symbols into a first winning combination or a second winning combination that is determined by the arrangement controller in relation to an input timing of the stop switch by the player.

8. The slot machine of claim 7, wherein the first winning combination is associated with a prescribed amount of payout, and the second winning combination is associated with a less amount of payout than the first winning combination.

9. The slot machine of claim 7, wherein the arrangement controller notifies those symbols that can be rearranged by an input of the stop switch by the player, to the player, when the symbols are rearranged into the specific combination on the display and the stop switch is set active.

10. The slot machine of claim 8, wherein the arrangement controller sets the stop switch inactive and rearranges the symbols into the second winning combination, when the symbols were not rearranged into either one of the first winning combination and the second winning combination by an input of the stop switch by the player.

11. A playing method of a slot machine, comprising:
repeating unit games in which a plurality of symbols are rearranged from a state of being arranged on a display into a combination of symbols determined by a controller; and
accepting an arrangement signal due to an operation of a player at the controller and enabling rearrangement of the symbols into a plurality of winning combinations, only in a case where a combination of symbols rearranged on the display is a specific combination of symbols.

12. The playing method of claim 11, further comprising:
notifying the plurality of winning combinations into which the symbols can be rearranged upon accepting the arrangement signal due to the operation of the player, to the player by the controller.

13. The playing method of claim 11, further comprising:
rearranging the symbols into one of the plurality of winning combinations by not accepting the arrangement signal due to the operation of the player at the controller, when the symbols were not rearranged into any of the plurality of winning combinations by the arrangement signal due to the operation of the player.

14. A playing method of a slot machine, comprising:
determining a plurality of symbols to be rearranged at a controller, and enabling rearrangement of the plurality of symbols independently from a control of the controller by a stop switch connected to the controller, prior to the rearrangement, in a case of arranging the plurality of symbols on a display and rearranging the plurality of symbols arranged on the display;
rearranging the plurality of symbols by the combination of symbols on the display;
enabling rearrangement of the plurality of symbols into a first winning combination associated with a prescribed amount of payout or a second winning combination associated with a less amount of payout than the first winning combination on the display, in a case where the combination of symbols rearranged on the display is a specific combination; and
setting the stop switch active such that the rearrangement of the plurality of symbols is controlled by an input of the stop switch, in a case where the combination of symbols rearranged on the display is the specific combination.

15. The playing method of claim 14, further comprising:
notifying the first winning combination to the player by the controller, when the plurality of symbols are rearranged into the specific combination.

16. The playing method of claim 14, further comprising:
setting the stop switch inactive and rearranging the plurality of symbols into the second winning combination, when the plurality of symbols were not rearranged into either one of the first winning combination and the second winning combination by an input of the stop switch.

17. A playing method of a slot machine, comprising:
repeating a unit game in which a game is started as a plurality of symbols arranged on a display are scrolled by a control of a controller and a game is ended as the plurality of symbols are rearranged into a combination of symbols determined by the controller;
setting a first control state in which the plurality of symbols scrolled on the display can be rearranged into a first winning combination or a second winning combination, according to an arrangement signal from a stop switch connected to the controller, in a case where the plurality of symbols are rearranged into a specific combination by the controller;
judging whether the combination of symbols rearranged on the display is either one of the first winning combination and the second winning combination or not, in the first control state; and
ending the unit game, and making a transition to a second control state in which the plurality of symbols are automatically rearranged from a state of being scrolled into the second winning combination by the controller, without being influenced by the arrangement signal from the stop switch, in a case where the combination of symbols rearranged on the display is judged as neither the first winning combination nor the second winning combination.
